(19) United States
(12) Patent Application Publication
(10) Pub. No.: US 2013/0007105 A1
(43) Pub. Date: Jan. 3, 2013

(54) SYSTEM AND METHOD FOR AUTOMATICALLY EXCHANGING LOGISTIC INFORMATION, AND STORAGE MEDIUM THEREOF

(75) Inventor: Li-Jen Chen, Taipei (TW)

(73) Assignee: Dimerco Express (Taiwan) Corporation, Taipei (TW)

(21) Appl. No.: 13/219,149

(22) Filed: Aug. 26, 2011

(30) Foreign Application Priority Data
Jun. 29, 2011 (TW) 100122922

(51) Int. Cl. G06F 15/16

(52) U.S. Cl. 709/203

(57) ABSTRACT

A system and method is provided for automatically exchanging a set of logistic information between information client stations. A central information server is used to retrieve a logistic message file from an origin information client station and transmit to a destination information client station. In the origin information client station, multiple digital logistic data corresponding to the logistic information are retrieved, serialized, encrypted and compressed to form the logistic message file. According to the origin-destination information of the logistic message file, the central information server builds a FTP (File Transfer Protocol), connection with the origin information client station, and the destination information client station respectively to retrieve and transmit the logistic message file. The destination information client station decompresses, decrypts, and parses the logistic message file into the digital logistic data corresponding to the logistic information.

### CROSS-REFERENCES TO RELATED APPLICATIONS

This non-provisional application claims priority under 35 U.S.C. §119(a) on Patent Application No. 100122922 filed in Taiwan, R.O.C. on 2011 Jun. 29, the entire contents of which are hereby incorporated by reference.

### BACKGROUND OF THE INVENTION

1. Field of Invention

The present invention relates to processing technologies of logistic information, and in particular to a system and method for automatically exchanging logistic information.

2. Related Art

Accompanying developments of optoelectronics technology, proximity switching devices have been widely applied to various machines, e.g. smart phone, transportation ticketing system, digital camera, remote control, liquid crystal displays (LCD), etc. A common proximity switching device includes a proximity sensor and a touch panel.

In the logistics industry, basic methods of transmitting logistic information are to transmit sending or receiving notices through facsimiles, phone calls or emails. For example, the way to exchange logistic information between different local offices of a logistic company is to input the logistic information of a delivery case manually into a managing system when the receiving side has received the messages on facsimiles, phone calls or emails.

Aside from the additional communication costs incurred from facsimiles and phone calls, such an operating method may also experience problems during the processes of transmitting and receiving logistic information. For example, due to negligence of the individual on the transmitting end, incorrect information may be sent out; conversely, the receiver may also make mistakes while receiving or inputting the information. Any mistake incurred during the transmission processes results in incorrect sequent processes in the logistic operation.

Furthermore, if the information transmission is processed through the internet by default, the information cannot be transmitted, or the information could be lost due to the internet going offline During information transmitting processes, information leakage could occur due to illegal access by external parties.

### SUMMARY

Accordingly, in an embodiment of the disclosure a system for automatically exchanging logistic information is provided. The system includes a startpoint information client station, a central information server and a destination information client station. The startpoint information client station stores multiple digital logistic data corresponding to a set of logistic information input by a startpoint user into a startpoint information-client database. The startpoint information client station further encrypts and compresses the digital logistic data to generate a logistic message file and store into a startpoint information-client file subsystem. The central information server enquires to find the logistic message file and a startpoint-destination information from the startpoint information client station, and establishes a startpoint-relay FTP (File Transmission Protocol), connection with the startpoint information client station. The central information server retrieves then the logistic message file and stores into a central file subsystem of the central information server. The destination information client station establishes a relay-destination FTP connection with the central information server to receive the logistic message file transmitted from the central information server. The logistic message file is decompressed, decrypted and parsed into the digital logistic data corresponding to the logistic information.

In another embodiment, a method for automatically exchanging logistic information is provided with the following sections; at a startpoint information client station, storing multiple digital logistic data corresponding to a set of logistic information input by a startpoint user into a startpoint information-client database; encrypting and compressing the digital logistic data to generate a logistic message file and store into a startpoint information-client file subsystem of the startpoint information client station; according to a startpoint-destination information of the logistic message file, establishing a startpoint-relay FTP (File Transmission Protocol), connection between a central information server and the startpoint information client station, and establishing a relay-destination FTP connection between the central information server and a destination information client station; retrieving and transmitting the logistic message file through the central information server; receiving the logistic message file at the destination information client station; and decompressing, decrypting and parsing the logistic message file into the digital logistic data corresponding to the logistic information.

In another embodiment, a computer-readable storage medium stores multiple computer-executable commands thereon. A method for automatically exchanging logistic information is executed when these computer-executable commands are executed. The method for automatically exchanging logistic information includes the following sections; at a startpoint information client station, storing multiple digital logistic data corresponding to a set of logistic information input by a startpoint user into a startpoint information-client database; encrypting and compressing the digital logistic data to generate a logistic message file and store into a startpoint information-client file subsystem of the startpoint information client station; according to a startpoint-destination information of the logistic message file, establishing a startpoint-relay FTP (File Transmission Protocol), connection between a central information server and the startpoint information client station, and establishing a relay-destination FTP connection between the central information server and a destination information client station; retrieving and transmitting the logistic message file through the central information server; receiving the logistic message file at the destination information client station; and decompressing, decrypting and parsing the logistic message file into the digital logistic data corresponding to the logistic information.

### BRIEF DESCRIPTION OF THE DRAWINGS

The disclosure will become more fully understood from the detailed description given herein below for illustration only, and thus are not limitative of the disclosure, and wherein:

FIG. 1 is a systematic architecture diagram of a system for automatically exchanging logistic information according to an embodiment;

FIG. 2 is a systematic diagram of a central information server according to another embodiment;

FIG. 3 is a systematic diagram of an information client station according to another embodiment;

FIG. 4A is a system block diagram of an information-client file subsystem in an information client station according to another embodiment;

FIG. 4B is a system block diagram of another information-client file subsystem in another information client station according to another embodiment;

FIG. 5 is an explanatory flow chart of a method for automatically exchanging logistic information according to another embodiment; and

FIG. 6 is a partial picture of an actual logistic operation form according to another embodiment.

### DETAILED DESCRIPTION

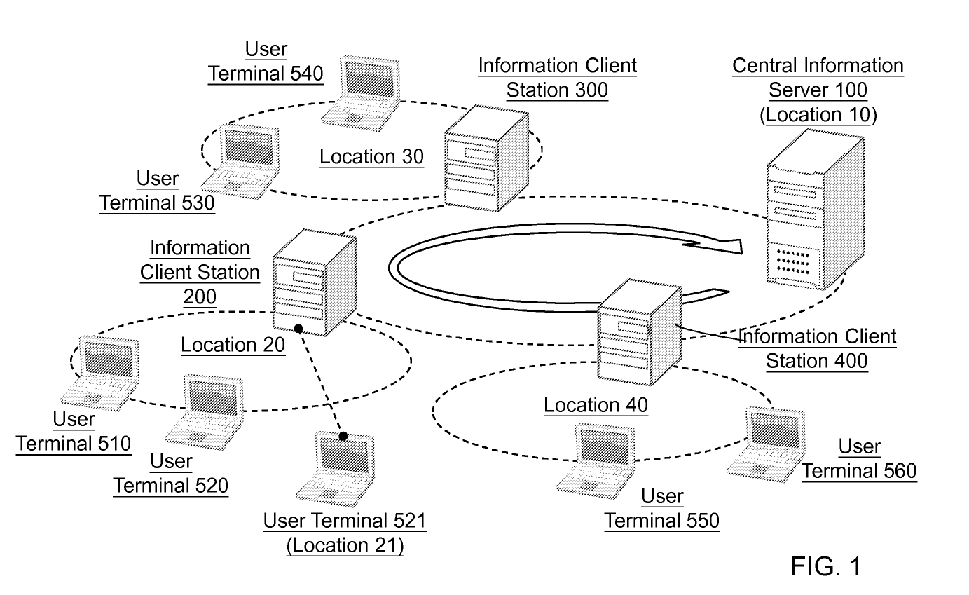

Please refer to FIG. 1, which is a systematic architecture diagram of a system for automatically exchanging logistic information according to an embodiment. In the present embodiment, a system and method for automatically exchanging logistic information are to transmit one or more sets of logistic information between a central information server 100 and multiple information client stations 200/300/400. Central information server 100 and information client stations 200/300/400 are located at different locations. Central information server 100 is located at location 10, while information client stations 200/300/400 are respectively located at locations 20/30/40. Each of the information client stations 200/300/400 located at locations 20/30/40 may be logged in for use by local users respectively via user terminals 510/520/530/540/550/560 located at locations 20/30/40. These locations 10/20/30/40 may include different ranges of geographical scopes. Although in FIG. 1 none of the actual geographical locations, amounts and relative distances is indicated, the amount of information client stations in actual practice may be dozens or hundreds, each of which may be located in Asia, Europe, America, Africa and Oceania respectively.

In FIG. 1, central information server 100 is able to establish communication networks through wired/wireless, private/public networks between multiple information client stations 200/300/400, such that multiple sets of logistic information are able to exchange in between. Detailed descriptions are provided in the following sections.

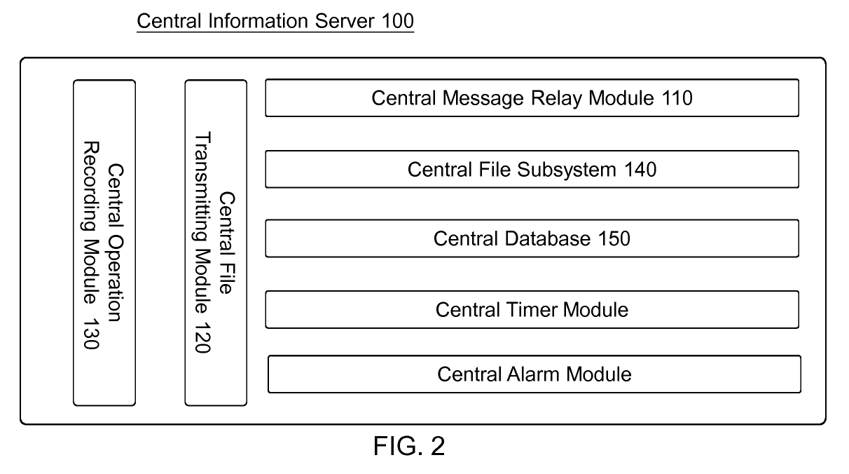

Please refer to FIG. 2, which is a systematic diagram of a central information server according to another embodiment. Central information server 100 is a computer system, which mainly includes a central message relay module 110, a central file transmitting module 120, a central operation recording module 130, a central file subsystem 140 and a central database 150. Each of these modules is able to be realized by executing certain procedures through a central processing unit and system memory of central information server 100; the functions and definitions of the modules are provided in the following sections.

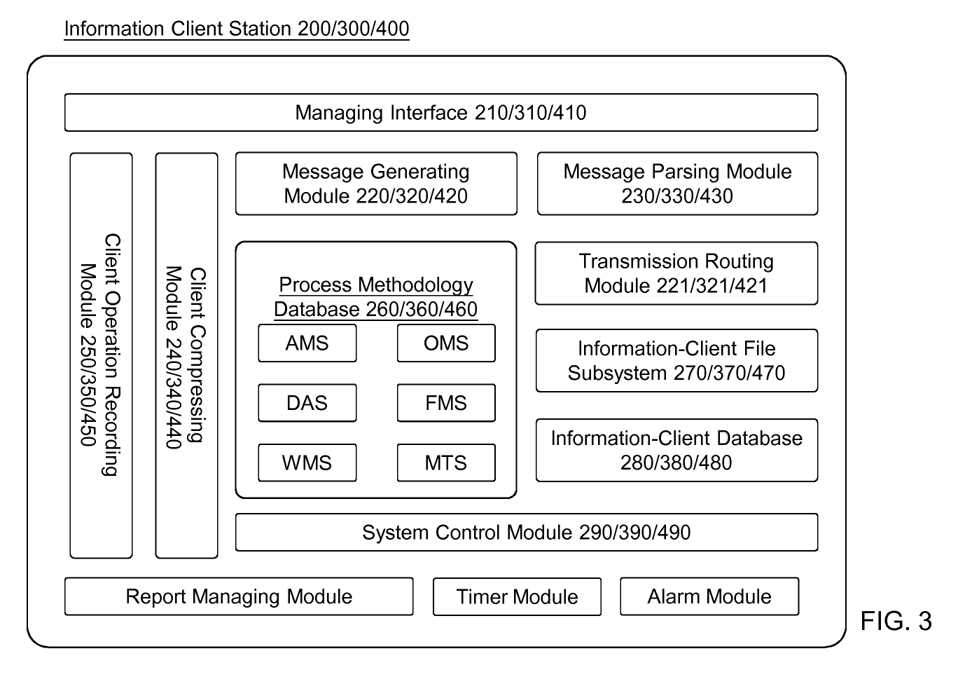

Please refer to FIG. 3, which is a systematic diagram of an information client station according to another embodiment. Each of information client stations 200/300/400 is another computer system respectively, which mainly includes a managing interface 210/310/410, message generating module 220/320/420, transmission routing module 221/321/421, message parsing module 230/330/430, client compressing module 240/340/440, client operation recording module 250/350/450, process methodology database 260/360/460, information-client file subsystem 270/370/470, information-client database 280/380/480 and system control module 290/390/490. Each of the modules, databases or subsystem is able to be realized by performing certain procedures via the central processing module, system memory and system storage of the information client station 200/300/400; the related definitions and functions are further described in the following sections.

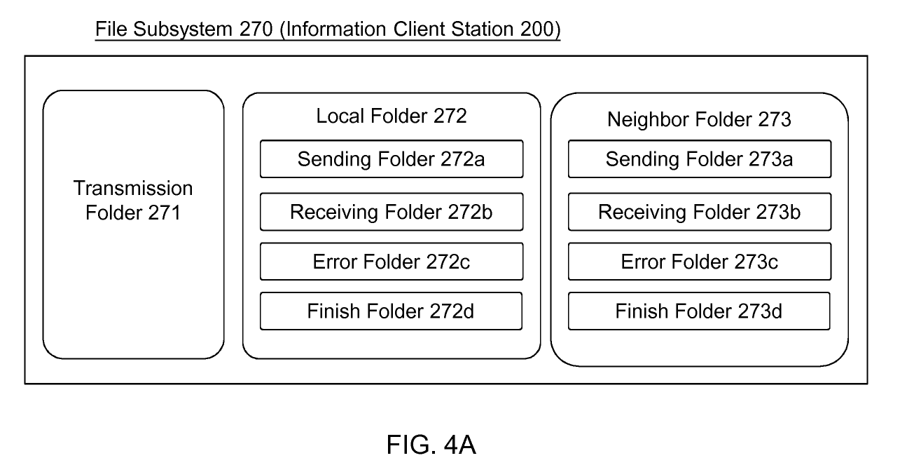

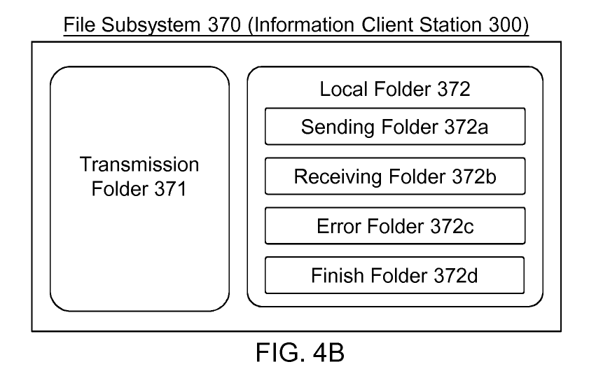

Please refer to FIG. 4A, which is a system block diagram of an information-client file subsystem in an information client station according to another embodiment. In an embodiment, information-client file subsystem 270 of information client station 200 mainly includes transmission folder 271, local folder 272 and neighbor folder 273. Local folder 272 includes sending folder 272a, receiving folder 272b, error folder 272c and finish folder 272d. Logistic message files sent from central information server 100 is stored in receiving folder 272b of information-client file subsystem 270; the logistic message files about to be transmitted are stored in sending folder 272a of information-client file subsystem 270; when errors incur during transmission, the logistic message file under transmission is able to be stored in error folder 272c of information-client file subsystem 270; those logistic message files that are finished transmitting may be stored in finish folder 272d of information-client file subsystem 270.

Similar to local folder 272, neighbor folder 273 also includes sending folder 273a, receiving folder 273b, error folder 273c and finish folder 273d. Neighbor folder 273 is set for the user terminal 521 located at a neighboring location 21; since the logistic processing loading at location 21 is not enough to independently set up a dedicated information client station, folders of its file subsystem is set under the information-client file subsystem 270. Thus, another transmission type for logistic message file is further derived. Specifically, when transmission routing module 221 of information client station 200 determines that the startpoint and destination are both the same information client station 200, the logistic message file may not be retrieved back to central information server 100; instead, the logistic message file is delivered inside the information-client file subsystem 270.

Please refer to FIG. 4B, which is a system block diagram of another information-client file subsystem in another information client station according to another embodiment;

In an embodiment, information-client file subsystem 370 of information client station 300 includes transmission folder 371 and local folder 372. Here local folder 372 includes sending folder 372a, receiving folder 372b, error folder 372c and finish folder 372d. Each of these folders has similar definitions and functions as those inside information-client file subsystem 270 and is not further explained in this section.

Please refer to the drawings from FIG. 1 to FIG. 4B. The central message relay module 110 is adapted to set up a Relay Sever Group respectively with information-client file subsystem 270/370/470 of information client station 200/300/400. Therefore, central message relay module 110 is able to periodically enquire every information client station 200/300/400 of information-client file subsystem 270/370/470; in an embodiment, the enquiring period is 5 minutes.

Central file transmitting module 120 performs one or more File Transfer Protocol procedures (FTP procedures), such as FTP-Client Procedures, so as to set up a FTP Connection with each of information-client file subsystem 270/370/470 in information client station 200/300/400. After such an FTP connection is established, the central message relay module 110 is able to respectively retrieve logistic message files from or deliver to information-client file subsystem 270/370/470 in the information client station 200/300/400.

The central operation recording module 130 records every log file regarding to the transmission or receiving of the logistic message file of the central information server 100, and then the central operation recording module 130 stores the log files in central database 150. Central operation recording module 130 is able to synchronize with every client operation recording module 250/350/450 of information client station 200/300/400, such that central information server 100 is able to store complete sets of information from branch offices all over the world.

Central file subsystem 140 may have the similar structure as the information-client file subsystem 370 of information client station 300 in FIG. 4B. Specifically, central file subsystem 140 may include transmission folder and local folder; wherein local folder includes sending folder, receiving folder, error folder and finish folder. The logistic message files retrieved from some startpoint information client station may be stored in receiving folder of the central file subsystem 140; those logistic message files about to be transmitted to a destination information client station are able to be stored in sending folder of the central file subsystem 140; when transmission error incurs, the logistic message file under transmission may be stored in the error folder of the central file subsystem 140; those finish transmitting may be stored in finish folder of central file subsystem 140.

In an embodiment, central information server 100 further includes a central timer service module and a central alarm module, as shown in FIG. 2. The central timer service module schedules tasks or events to timely initiate various logistic operation tasks or events of central information server 100. Central alarm module sends notice messages or emails to a preset address when any malfunction of processing logistic information in central information server 100 incurs.

Managing interface 210/310/410 of information client station 200/300/400 provide a setting interface for system managers to display and set certain settings such as the connection settings between information client station 200/300/400 and central information server 100, the frequency of receiving and parsing the logistic message files, or transmission log files or receiving records. System control module 290/390/490 provides another setting interface regarding information client station 200/300/400 itself.

Message generating module 220/320/420 mainly operates when information client station 200/300/400 is set as a startpoint when transmitting logistic information. According to the category of logistic information and one of the logistic processing procedures stored in process methodology database 260/360/460, the message generating module 220/320/420 retrieves digital logistic data from information-client database 280/380/480 corresponding to the logistic information input by a user. Then message generating module 220/320/420 generates a logistic message file from the retrieved digital logistic data, encrypts and compresses the generated logistic message file and stores into information-client file subsystem 270/370/470. In an embodiment, the logistic processing procedures stored in process methodology database 260/360/460 may include various types of logistic processing procedures and business logics designed for different logistic stages or logistic types, which may be defined as AMS (Airfreight Managing System), WMS (Warehouse Managing System), DAS (Domestic Airfreight System), FMS (Financing Managing System), MTS (Multiple Transportation managing System). When generating the logistic message file, the compressing operation is performed by compressing module 240/340/440. The retrieving process of the digital logistic data is further described in the following section.

Transmission routing module 221/321/421 mainly operates when information client station 200/300/400 is set as a startpoint when transmitting logistic information. According to a Startpoint Code and a Destination Code of the logistic message file, transmission routing module 221/321/421 is able to determine whether the possible transmission route is an internal path or an external path. When a transmission route is determined as an internal path, the logistic message file is only delivered between the local folder 272 and neighbor folder 273 within information-client file subsystem 270 in FIG. 4A. When the transmission route is an external path, taking the information client station 200/300 as an example, the logistic message file is then store in sending folder 272a/372a of information-client file subsystem 270/370 and waiting for being transmitted to central information server 100.

Message parsing module 230/330/430 mainly operates when information client station 200/300/400 is set as the destination when transmitting logistic information. Message parsing module 230/330/430 retrieves the logistic message file transmitted from central information server 100 and stored in receiving folder (such as 272b, 273b or 372b) of information-client file subsystem (such as 270/370), and then decompresses and parses the logistic message file into digital logistic data, and store the digital logistic data into information-client database 280/380/480.

Client Operation Recording Module 250/350/450 respectively records all the log files of transmitting or receiving every logistic message file in information client station 200/300/400, and stores the log files in information-client database 280/380/480 respectively. Client Operation Recording Module 250/350/450 of Information client station 200/300/400 is able to synchronize with central operation recording module 130 such that central information server 100 is able to store the complete information from every information client station all over the world.

In an embodiment, information client station 200/300/400 further includes a report managing module, a timer service module and an alarm module, as shown in FIG. 3. The report managing module outputs corresponding statistics diagrams/charts according to the digital logistic data stored in information-client database 280/380/480, and the transmitting or receiving records (or log files) of the logistic message files. The timer service module schedules tasks or events to timely initiate various logistic operation tasks or events in information client station 200/300/400. The alarm module sends notice messages or emails to a preset address when any malfunction of processing logistic information in information client station 200/300/400 incurs.

In the following sections, through examples of establishing and transmitting logistic information, a system and method for automatically exchanging logistic information are further explained.

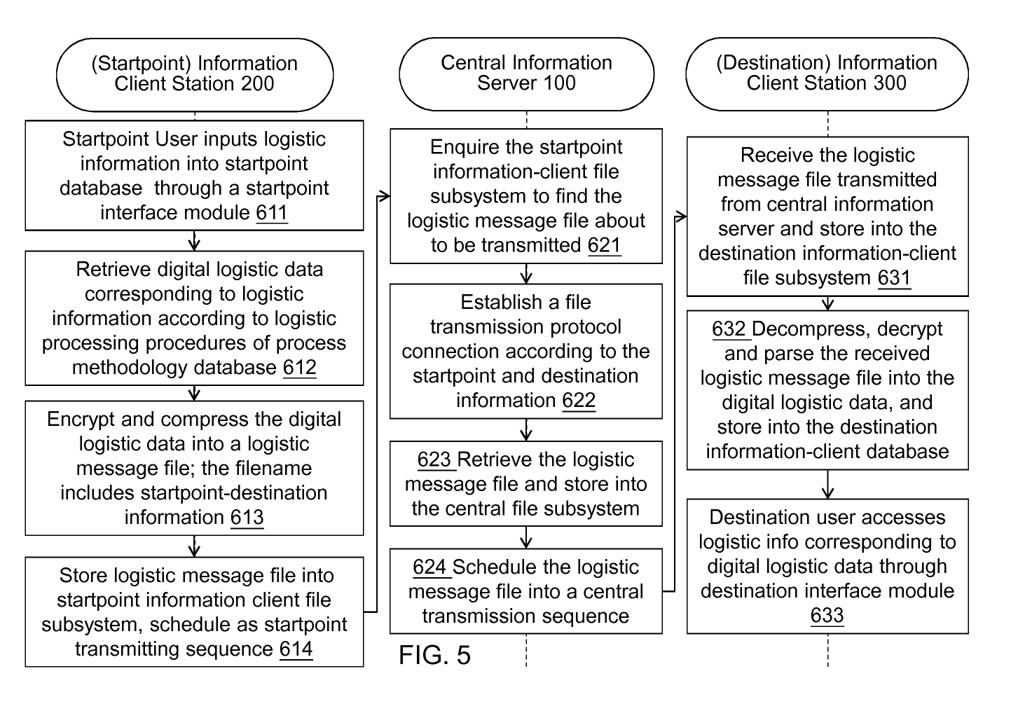

Please jointly refer to FIG. 1 to FIG. 5, where FIG. 5 is an explanatory flow chart of a method for automatically exchanging logistic information according to another embodiment. In another embodiment, a system for automatically exchanging logistic information includes a information client station 200 set as a startpoint information client station, a central information server 100 and another information client station 300 set as a destination information client station; the system for automatically exchanging logistic information is used to perform a method for automatically exchanging logistic information. Although the method for automatically exchanging logistic information below is explained and described through a flow chart and corresponding steps, all portions of a method for automatically exchanging logistic information are not limited to the sequence below.

(1) Startpoint Information Client Station (Information Client Station 200):

Step 611: A user at the startpoint inputs logistic information into a startpoint information-client database of the startpoint information client station through a startpoint interface module (not shown).

A user at location 20 is able to operate the startpoint interface module (not shown) through user terminal 510 or 520, and input logistic information into the start point information-client database (information-client database 280). The startpoint interface module is able to be realized by performing a set of ERP (Enterprise resource planning), procedures through the central processing module and system memory of startpoint information client station; specifically, the startpoint interface module includes at least a portion of Enterprise resource planning procedures. An ERP procedure includes computer based processes incorporated with necessary information and business logics.

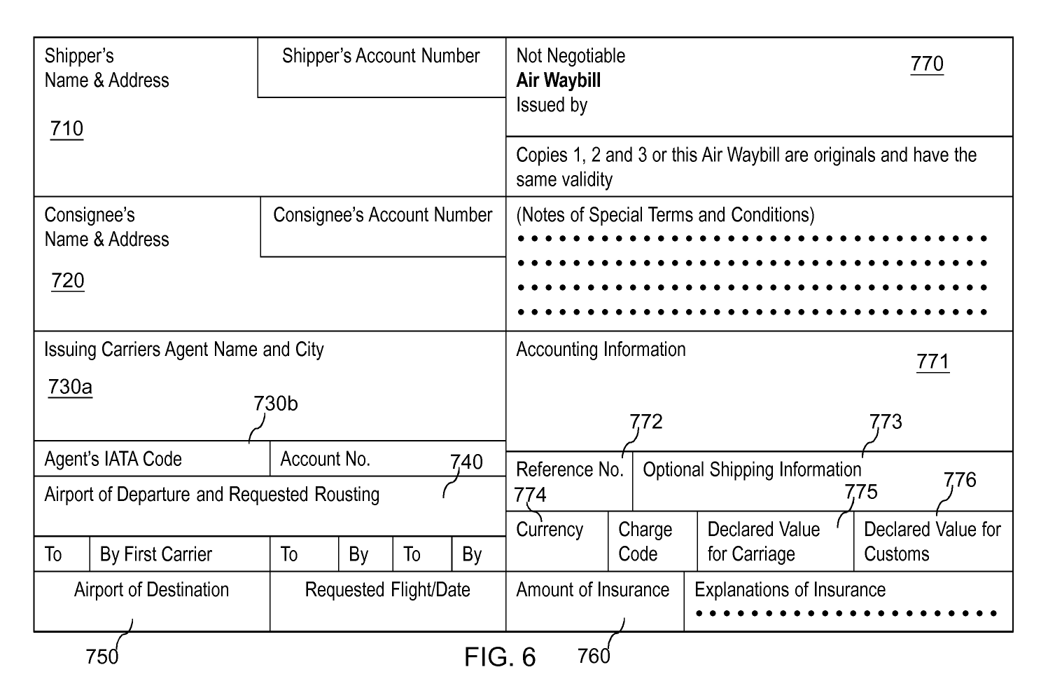

FIG. 6 is a partial picture of an actual logistic operation form according to another embodiment. As shown in the drawing, the logistic operation form is an “Airway Bill” form with multiple columns; these columns are where a user is allowed to input different necessary logistic information. For example, “Shipper's Name and Address” is defined as sender or shipper information 710; “Consignee's Name and Address” is defined as receiver information 720. Furthermore, sets of information regarding the logistic transporter mainly include issuing carrier's information 730a “Issuing Carrier's Agent Name and City” and registration code of the logistic transporter 730b “Agent's IATA Code” (a registration code granted from International Air Transport Association to the logistic transporter). Other sets of logistic information include Airport of Departure 740, Airport of Destination 750, insurance information 760 “Amount of Insurance”, airway bill issuer 770 “Airway Bill/Issue by”, Accounting Information “Accounting Information” 771, reference number 772 “Reference Number”, optional shipping information 773 “Optional Shipping Information”, payment information 774, declared value for carriage 775 “Declared Value for Carriage”, declared value for carriage 776 “Declared Value for Carriage” and other information. Since every set/column of the input logistic information is required to be filled in difference logistic operation forms during the whole logistic operation process, these sets of the input logistic information are not directly stored in the format of a specific logistic operation form (such as the Airway Bill form in FIG. 6); instead, the sets of logistic information are redefined as digital logistic data and stored into the startpoint information-client database (information-client database 280). When different logistic operation forms need to be generated, the corresponding digital logistic data are retrieved and filled into the columns arranged in different formats of different logistic operation forms. Specifically, the system and method for automatically exchanging logistic information according to this disclosure, do not directly transmit the whole formats of different logistic operation form; only the digital logistic data corresponding to the corresponding sets of logistic information are transmitted.

Step 612: Retrieve the digital logistic data corresponding to the sets of logistic information according to the logistic processing procedures stored in process methodology database.

Different types/categories or operating stages require different logistic processing procedures. That means different sets of logistic information are required. The digital logistic data corresponding to the sets of logistic information must therefore be retrieved according to the logistic processing procedures stored in process methodology database; wherein the digital logistic data is defined corresponding to specific logistic information input in one or more certain columns.

Step 613: Encrypt and compress the retrieved digital logistic data into a logistic message file; the filename of the logistic message file includes startpoint-destination information. The startpoint-destination information includes the information of the startpoint and the destination of the logistic message file. For example, in another embodiment, the file name of another logistic message file is:

Main Filename: ZJDSHA_DIMTPE_AIREMF_R_{—}20110521030405123

Sub Filename: XML

The 01-06 (first to sixth), digits of the main filename are defined as the destination code; the 08-13 (eighth to thirteenth), digits are defined as the startpoint code; the 15-20 (fifteenth to twentieth), digits are the message type (such as Airway); the 22 (twenty-second), digit is the message scope (indicating that the transmission route is an internal path or an external path); the 24-40 (twenty-forth to fortieth), digits are defined as the time generating the message file. The filename of the logistic message file is specifically described since the central file transmitting module 120 of central information server 100 is able to recognize the startpoint information client station and destination information client station from the file name of the logistic message file, so as to initiate the sequent transmission tasks. To determine the message scope defined at the 22th digit, the method is able to further include a step of determining whether the transmission route of the logistic message file is an internal path or an external path.

Step 614: Store the logistic message file into the startpoint information-client file subsystem, and schedule into a startpoint transmitting sequence.

Since a Relay Sever Group is established between central message relay module 110 of central information server 100 and the information-client file subsystem 270/370/470 of information client station 200/300/400, the logistic message file has to be stored in to the sending folder (sending folder 272a of information-client file subsystem 270), of the startpoint information-client file subsystem, so that the logistic message file can be retrieved. When there are multiple logistic message files waiting to be transmitted, the system and method of the disclosure are able to transmit the logistic message files one by one by first determining a startpoint transmitting sequence according to the generated times of the logistic message files, their urgency or importance. The logistic message files are then transmitted according to the startpoint transmitting sequence.

When transmission routing module 221 of information client station 200 determines that the startpoint and the destination are both located at the same information client station 200, the logistic message file does not need to be retrieved back to the central information server 100. Therefore, when the filename of the logistic message file includes the 22th digit indicating an internal path as the message scope, the logistic message file is only moved from the sending folder (such as Sending folder 272a), of the local folder (such as Local folder 272), under the startpoint information-client file subsystem, to the receiving folder (the receiving folder 372b in FIG. 4A) of the neighbor folder (Neighbor Folder 273), under the same startpoint information-client file subsystem. Afterwards, the logistic message file is decompressed, decrypted and parsed back into the digital logistic data by the message parsing module 230, and then stored into information-client database 200. Through an interface module of the user terminal 521, the logistic information corresponding to the restored digital logistic data is able to be accessed.

(2) Central Information Server 100:

Step 621: Enquire the startpoint information-client file subsystem to find the sending logistic message file.

Central message relay module 110 is able to find the logistic message file about to be transmitted through enquiring the information-client file subsystem 270/370/470 of the information client station 200/300/400 at the startpoint.

Step 622: Establish a File Transmission Protocol (FTP), connection according to the startpoint and destination information. According to the startpoint-destination information defined in the filename of logistic message file, the central file transmitting module 120 finds that the startpoint information client station is information client station 200 and the destination information client station is information client station 300 in this case. Therefore, the central file transmitting module 120 must perform a File Transmission Protocol (FTP), procedure, so as to respectively establish a File Transmission Protocol (FTP), connection with each of the startpoint information client stations (information client station 200), and the destination information client station (information client station 300). To establish such FTP connections, the central file transmitting module 120 must perform a FTP-Client Procedure and both the startpoint information client station (information client station 200), and the destination information client station (information client station 300), must perform a FTP-Server Procedure respectively. The startpoint information client station is able to establish a Startpoint-Relay FTP connection with the central information server; while the destination information client station is able to establish a Relay-Destination FTP connection with the central information server. The timing of establishing the Relay-Destination FTP connection between the destination information client station and the central information server depends by demand; for example, the time is up after the logistic message file is retrieved by the central information server 100.

Step 623: Retrieve the logistic message file and store into the central file subsystem. After the Startpoint-Relay FTP connection is established, the central file transmitting module 120 is able to retrieve the logistic message file from the startpoint information client station (specifically the sending folder 272a under information-client file subsystem 270 of information client station 200), and then store it in the central file subsystem 140.

Step 624: Schedule the logistic message file into a central transmission sequence. When there are multiple logistic message files stored in the central file subsystem 140 and waiting to be transmitted, the central transmission sequence is defined according to the generated time, the urgency or the importance of each of logistic message files. These logistic message files are then transmitted according to the central transmission sequence.

Therefore, the system and method for automatically exchanging logistic information uses the central information server to retrieve and transmit logistic message files between the startpoint information client station and the destination information client station. Furthermore, the transmitted logistic message file is not exact the original logistic operation form; only digital logistic data corresponding to certain columns thereof are transmitted. After being encrypted and compressed, the logistic message file is able to achieve a high efficient file transmission and relatively lower possibility of information leaking.

(3) Destination Information Client Station (Information Client Station 300):

Step 631: Receive the logistic message file transmitted from the central information server and store into the destination information-client file subsystem. After the Relay-Destination FTP connection between the destination information client station (information client station 300), and the central information server 100 is established, the destination information client station is able to receive the logistic message file transmitted from the central information server 100, and store into the receiving folder 372b of local folder 372 under the destination information-client file subsystem (information-client file subsystem 370), of the destination information client station (information client station 300).

Step 632: Decompress, decrypt and parse the received logistic message file into the digital logistic data, and store into the destination information-client database. The message parsing module 330 of the destination information client station (information client station 300), retrieves the logistic message file from the destination information-client file subsystem (information-client file subsystem 370), to decompress, decrypt and parse into the digital logistic data, and then store into the information-client database (information-client database 380).

Step 633: A destination user accesses the logistic information corresponding to the digital logistic data through a destination interface module. In an embodiment, the user terminals 530, 540 at a destination location (location 30), include a destination interface module respectively that allows the destination user to log in the destination information client station (information client station 300), and access the logistic information corresponding to the digital logistic data and proceed with the sequent logistic operation procedures. The destination interface module is similar to startpoint interface module; both are able to be realized by performing ERP procedures through the central processing unit and system memory of the destination information client station. Specifically, the destination interface module includes at least a portion of Enterprise resource planning procedures.

According to the detailed descriptions in the embodiments presented here, the disclosure further includes a computer-readable storage medium stored with multiple computer-executable commands. The method for automatically exchanging logistic information according to the embodiment presented here is executed when these computer-executable commands are executed.

While the disclosure has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A system for automatically exchanging logistic information, comprising:
a startpoint information client station, storing a plurality of digital logistic data corresponding to at least a set of logistic information input by a startpoint user into a startpoint information-client database, encrypting and compressing the digital logistic data to generate a logistic message file and store into a startpoint information-client file subsystem;
a central information server, enquiring to find the logistic message file and a startpoint-destination information from the startpoint information client station, and establishing a startpoint-relay FTP (File Transmission Protocol) connection with the startpoint information client station, the central information server retrieving the logistic message file and storing into a central file subsystem of the central information server; and
at least a destination information client station, establishing a relay-destination FTP connection with the central information server to receive the logistic message file transmitted from the central information server, the logistic message file being decompressed, decrypted and parsed into the digital logistic data corresponding to the logistic information.

2. The system according to claim 1, wherein a filename of the logistic message file comprises the startpoint-destination information.

3. The system according to claim 1, wherein the startpoint information client station comprises a process methodology database, and the startpoint information client station retrieves at least a portion of the digital logistic data according to at least one logistic processing procedure stored in the process methodology database.

4. The system according to claim 1, wherein the central information server executes a FTP-Client Procedure, and the startpoint information client station and the destination information client station respectively execute a FTP-Server Procedure, so as to establish the startpoint-relay FTP connection and the relay-destination FTP connection respectively.

5. The system according to claim 1, wherein the startpoint information client station, the central information server and the destination information client station respectively records a log file of transmitting the logistic message file.

6. The system according to claim 1, wherein the logistic message file received from the central information server is stored into a destination information-client file subsystem of the destination information client station.

7. The system according to claim 1, wherein a startpoint interface module is used by the startpoint user to input the logistic information, and a destination user accesses the logistic information through a destination interface module, each of the startpoint interface module and the destination interface module comprising at least an Enterprise Resource Planning (ERP) procedure.

8. A method for automatically exchanging logistic information, comprising:
at a startpoint information client station, storing a plurality of digital logistic data corresponding to at least a set of logistic information input by a startpoint user into a startpoint information-client database;
encrypting and compressing the digital logistic data to generate a logistic message file and store into a startpoint information-client file subsystem of the startpoint information client station;
according to a startpoint-destination information of the logistic message file, establishing a startpoint-relay FTP (File Transmission Protocol) connection between a central information server and the startpoint information client station, and establishing a relay-destination FTP connection between the central information server and a destination information client station;
retrieving and transmitting the logistic message file through the central information server;
receiving the logistic message file at the destination information client station; and
decompressing, decrypting and parsing the logistic message file into the digital logistic data corresponding to the logistic information.

9. The method according to claim 8, wherein a filename of the logistic message file comprises the startpoint-destination information.

10. The method according to claim 8 further comprising a step of retrieving the digital logistic data according to at least a logistic processing procedure.

11. The method according to claim 8, wherein the central information server executes a FTP-Client Procedure, and the startpoint information client station and the destination information client station respectively execute a FTP-Server Procedure, so as to establish the startpoint-relay FTP connection and the relay-destination FTP connection respectively.

12. The method according to claim 8 further comprising a step of determining whether a transmission route of the logistic message file is an internal path or an external path.

13. The method according to claim 8 further comprising a step of outputting the logistic information corresponding to the digital logistic data.

14. The method according to claim 8 further comprising a step of recording a log file of transmitting the logistic message file.

15. A computer-readable storage medium storing a plurality of computer-executable commands thereon, a method for automatically exchanging logistic information being executed when the computer-executable commands are executed, the method for automatically exchanging logistic information comprising:
at a startpoint information client station, storing a plurality of digital logistic data corresponding to at least a set of logistic information input by a startpoint user into a startpoint information-client database;
encrypting and compressing the digital logistic data to generate a logistic message file and store into a startpoint information-client file subsystem of the startpoint information client station;
according to a startpoint-destination information of the logistic message file, establishing a startpoint-relay FTP (File Transmission Protocol) connection between a central information server and the startpoint information client station, and establishing a relay-destination FTP connection between the central information server and a destination information client station;
retrieving and transmitting the logistic message file through the central information server;
receiving the logistic message file at the destination information client station; and
decompressing, decrypting and parsing the logistic message file into the digital logistic data corresponding to the logistic information.

16. The computer-readable storage medium according to claim 15, wherein a filename of the logistic message file comprises the startpoint-destination information.

17. The computer-readable storage medium according to claim 15 retrieving the digital logistic data according to at least a logistic processing procedure.

18. The computer-readable storage medium according to claim 15, wherein the central information server executes a FTP-Client Procedure, and the startpoint information client station and the destination information client station respectively execute a FTP-Server Procedure, so as to establish the startpoint-relay FTP connection and the relay-destination FTP connection respectively.

19. The computer-readable storage medium according to claim 15 further comprising a step of determining whether a transmission route of the logistic message file is an internal path or an external path.

20. The computer-readable storage medium according to claim 15 further comprising a step of outputting the logistic information corresponding to the digital logistic data.
